(19) United States
(12) Patent Application Publication
(10) Pub. No.: US 2007/0204467 A1
(43) Pub. Date: Sep. 6, 2007

(54) DICING AND CUTTING DEVICE

(76) Inventor: Mike Livie, Toronto (CA)

Correspondence Address: MARK A KOCH, 866 MAIN STREET EAST, HAMILTON, ON, L8M1L9, US

(21) Appl. No.: 11/679,353

(22) Filed: Feb. 27, 2007

Related U.S. Application Data
(60) Provisional application No. 60/767,063, filed on Mar. 1, 2006.

(51) Int. Cl. B26B 3/00

(52) U.S. Cl. 30/124

(57) ABSTRACT

A dicing and cutting device comprising a male top housing slideably co-operatively engaging with a female bottom housing, wherein the top housing including downwardly projecting top blades, and the bottom housing including upwardly projecting bottom blades, such that food stuffs located with a cavity defined within the housings are sliced and diced upon rotation of the top housing relative the bottom housing.

The application claims priority from previously filed U.S. provisional patent application No. 60/767,063, titled “DICING AND CUTTING DEVICE” on Mar. 1, 2006 by Mike Livie.

### FIELD OF THE INVENTION

The present invention relates to devices used for dicing and cutting primarily fruits, vegetables, herbs and spices and particularly relates to a kitchen utensil which is a dicing and cutting device.

### BRIEF DESCRIPTION OF THE DRAWINGS

The present invention will be described by way of example only with reference to the following drawings:

FIG. 1 is a top plan view of the bottom housing.

FIG. 2 is a side elevational view of the bottom housing.

FIG. 3 is a bottom plan view of the bottom housing.

FIG. 4 is a side elevational view of the bottom housing.

FIG. 5 is a cross sectional view taken along lines 5-5 in FIG. 1 of the bottom housing.

FIG. 6 is a bottom perspective view of the bottom housing.

FIG. 7 is a top perspective view of the bottom housing.

FIG. 8 is a top perspective view of the bottom blade holder.

FIG. 9 is an assembly drawing showing the bottom blade holder being position into the bottom housing.

FIG. 10 is a top plan view of the top housing.

FIG. 11 is a side elevational view of the top housing.

FIG. 12 is a bottom plan view of the top housing.

FIG. 13 is a side elevational view of the top housing.

FIG. 14 is a bottom perspective view of the top housing.

FIG. 15 is a top perspective view of the bottom housing.

FIG. 16 is a top plan view of the dicing and cutting device.

FIG. 17 is a side elevational view of the dicing and cutting device in a partial open position.

FIG. 18 is a side elevational view of the dicing and cutting device in the closed position.

FIG. 19 is a cross sectional view of the dicing and cutting device taken along lines 19-19 and FIG. 16.

FIG. 20 is a top perspective view of the dicing and cutting device in the open position.

FIG. 21 is a front side plan view of a single blade.

FIG. 22 is a top plan view of a single blade showing the radius of the blade.

FIG. 23 is a backside plan view of a single blade.

FIG. 24 is an end plan view of a single blade.

FIG. 25 is a top plan view of a three plan oriented and spaced apart as they would be in the blade holder.

FIG. 26 is a front side top perspective view of a single blade.

FIG. 27 is a back side top perspective view of a single blade.

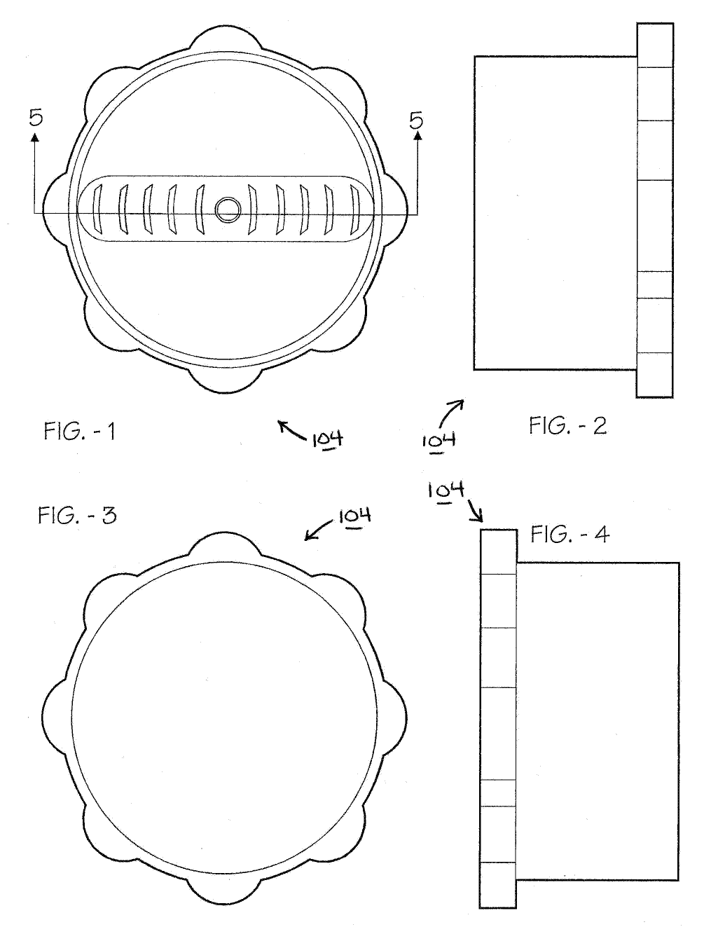

### DETAILED DESCRIPTION OF THE PREFERRED EMBODIMENT

The present invention a dicing and cutting device shown generally as 100 includes the following major components, namely male top housing 102, which cooperatively engage with female bottom housing 104. Cutting device 100 further includes top blade 106 and bottom blades 108, the top locating tube 110 slideably engaging with a bottom pin 111. Bottom housing 104 includes a bottom rim 114 and top housing 102, includes a top rim 112. Bottom rim 114 and top rim 112 are used to engage with the hand for rotating the top housing 102 relative to the bottom housing 104. Top blades 106 are held in position by top blade holder 118 and bottom blades 108 are held in position with bottom blade holder 120. Bottom housing 104 defines cavity 130 within tubular walls 16 and bottom rim 114. Food stuffs such as fruits, vegetables, herbs and spices are placed within cavity 130 and top housing 102 is slideably engaged into bottom housing 104 and is positively located with a bottom pin 111, slideably engaging with a top locating tube 110 such that it rotatably pivots about pivot axis 191. Other pivoting arrangements having the same function may also be used in place of the arrangement depicted. In the closed or engaged position as shown in FIGS. 18 and 19, the top housing 102 is rotated relative to bottom housing 104 by applying twisting action with left and right hand. Top blades 106 and bottom blades 108 interpenetrate, but do not make contact with each other.

With food stuffs such as vegetables, fruits, herbs and/or spices and/or any other items positioned within cavity 130 are sliced and diced as top housing 102 is rotated relative to bottom housing 104. Top blades 106 and bottom blades 108, sheer, cut, slice and dice any material within cavity 130 which makes contact with the blades.

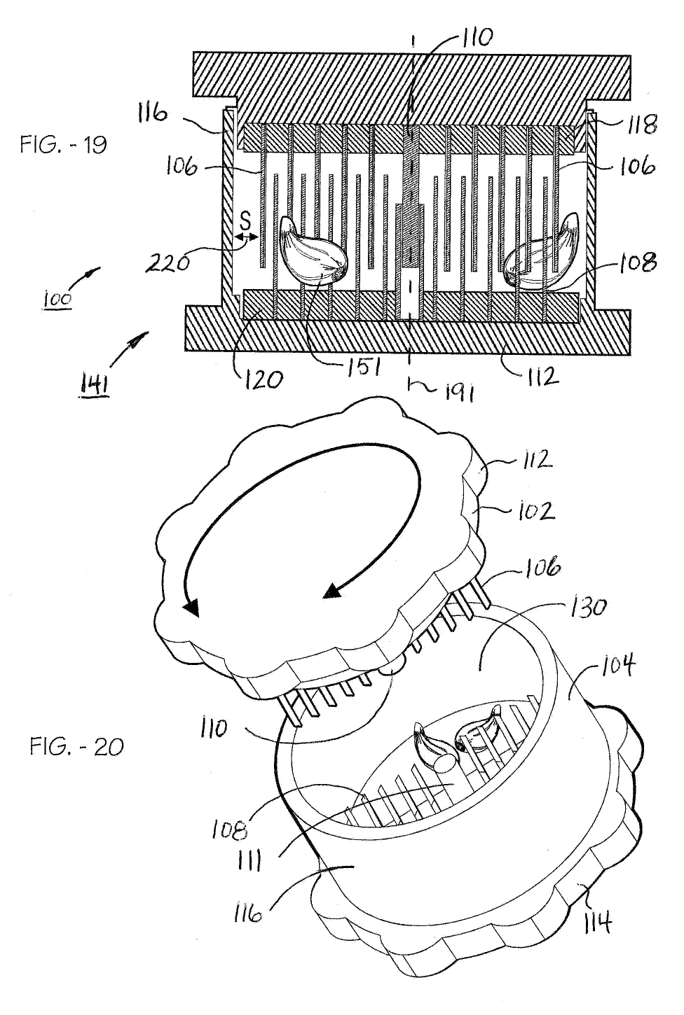

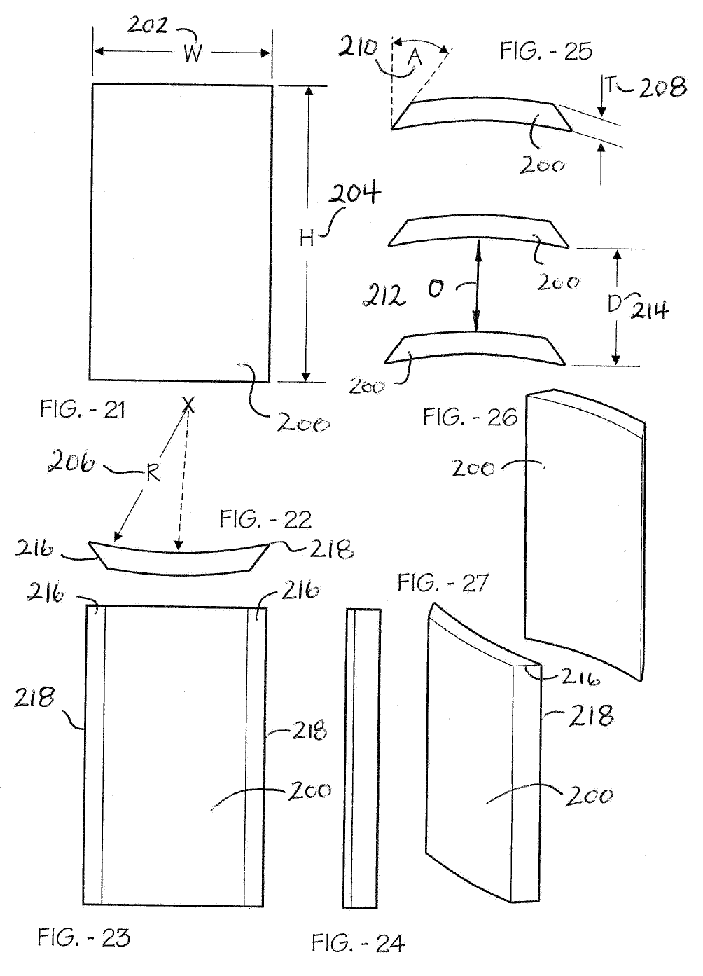

Top blades 106 and bottom blades 108 are preferably dimensionally the same and depicted as blades 200. Details of blade 200 are shown in FIGS. 21 through 27 inclusively. Blade 200 includes the following major features namely, blade 200 has a width shown as W 202 and a height shown as H 204, the blade has a curvature to it or a radius as shown as R 206 in FIG. 22. The blade also has a thickness shown as T 208 and a cutting angle A 210 related to each cutting edge 218. The opening shown as O is the space between the front side and the back side of two adjacent blades 200 and is shown as opening O 212 in FIG. 25. The distance between the blades D as shown in FIG. 25 is the distance from the cutting edge 218 of one blade to the adjacent blade cutting edge 218 and is shown as distance D 214.

Each blade 200 has a chamfered portion 216 related to each cutting edge 218.

Referring now to FIG. 19 in particular, the space between the inner diameter 230 of tubular wall 1116 and the outer most top blade 106 is shown as space S 220 in FIG. 19.

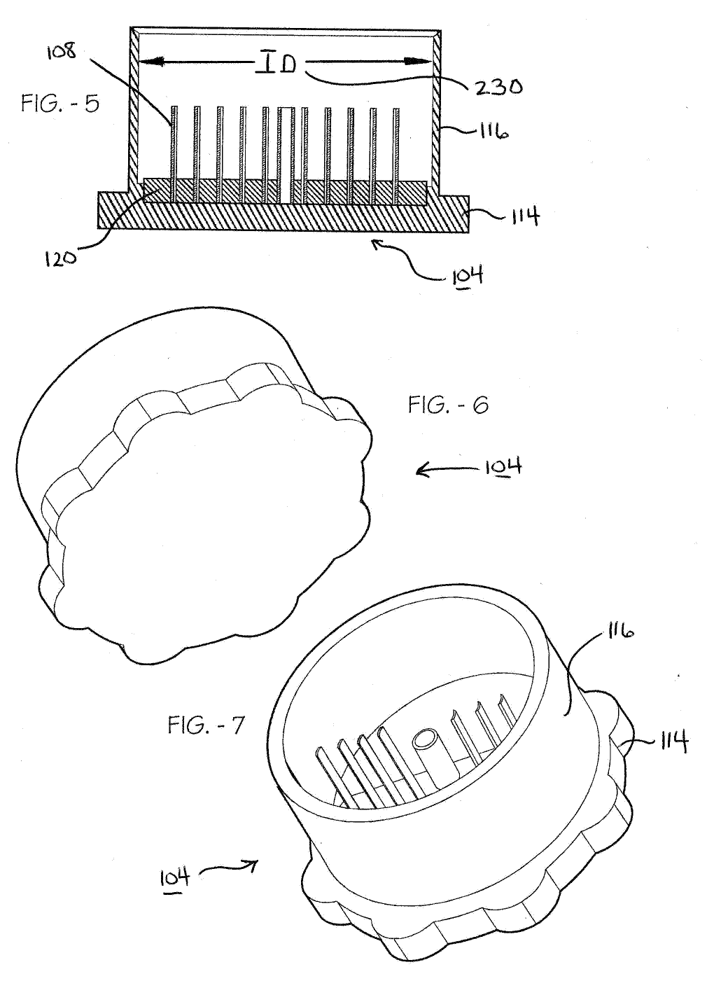

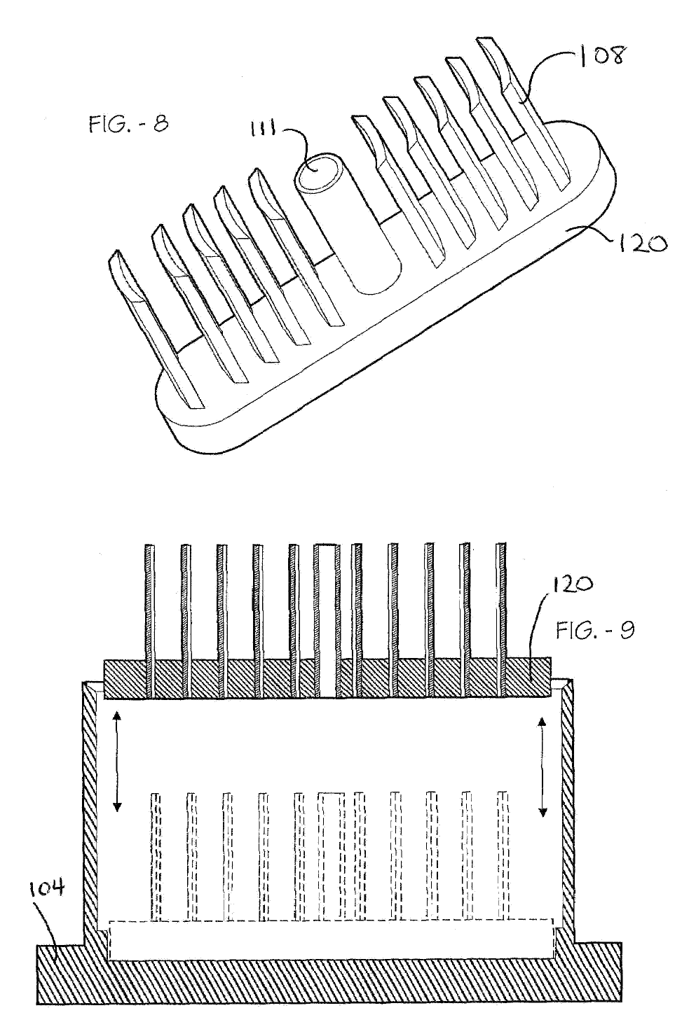

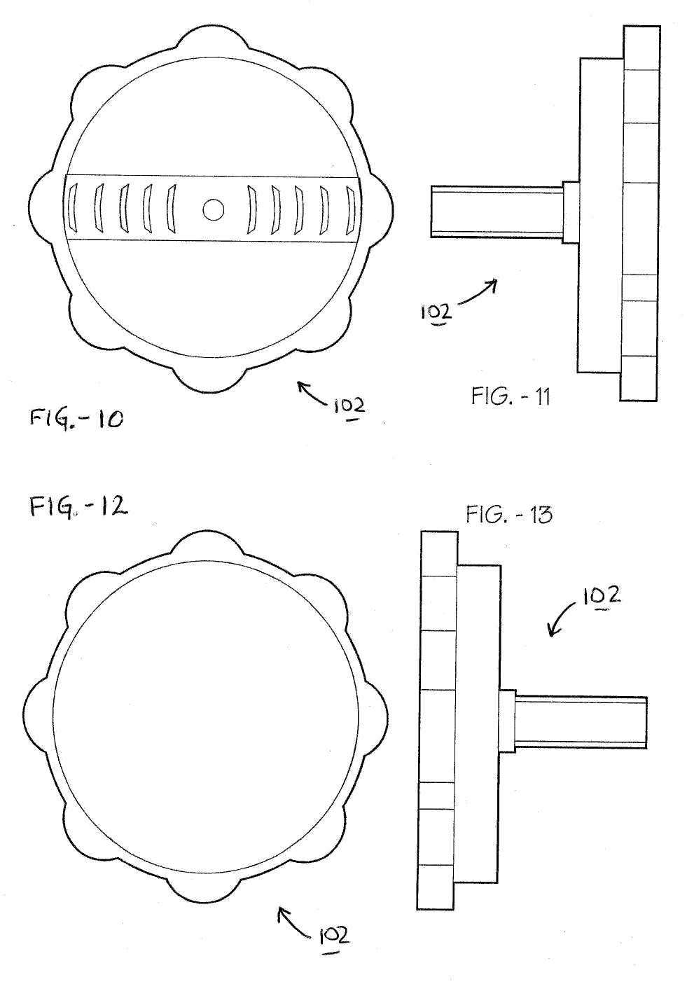

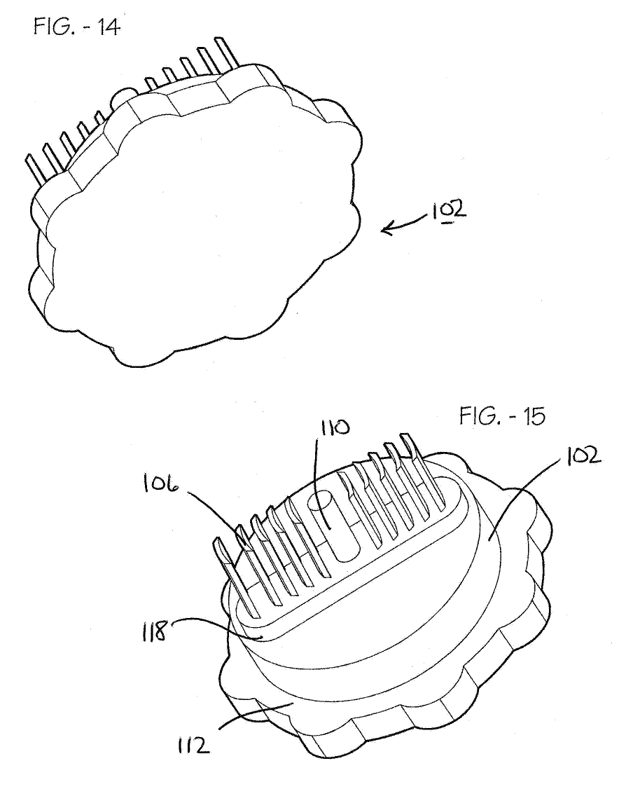

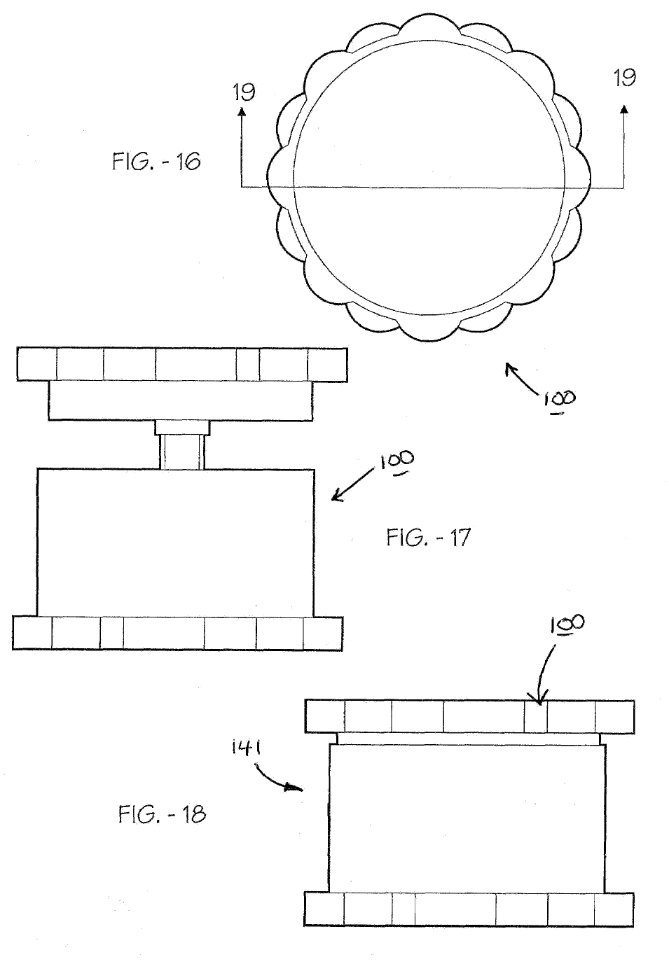

The inner diameter of bottom housing 104 is shown as ID 230 in FIG. 5.

The dimensions of blade 200 and other important dimensions of dicing and cutting device 100 are summarized below as follows:

### Dimension of Blade 200

### 230 ID=Inner Diameter=3″

### 202 W=Width=0.375″+/−0.125″

### 204 H=Height=0.75+/−0.25″

### 206 R=Radius=1.5″+/−0.5″=ID/2+/−0.5″

### 208 T=Thickness=0.035″+/−0.025″

### 210 A=Cutting Angle=31° (Range=21° to 55°)

### 212 O=Opening=0.165″

### 214 D=Distance=0.20+/−0.07

### 220 S=Space=0.18″ (Range=0.10″+0.22″)

The inventor has determined through trial and error testing that radius R 206 of blades 200 is preferably equal to ½ inner diameter ID 230 of tubular walls 116 of bottom housing 104. Therefore, as inner diameter ID 230 of tubular walls 116 of bottom housing 104 becomes smaller and/or larger, Radius R 206 is adjusted accordingly to maintain radius R 206 of approximately ID÷2+/−0.5″.

Therefore for the example given above, for a 3″ inner diameter ID 230, the preferable radius R 206 is 1.5″.

Preferably for a inner diameter ID 230=3″, the cutting angle A 210 is preferably 31° and the space S 220 between tubular wall 116 and outer most top blade 106 is preferably 0.18″ and the distance 214 between blades is preferably 0.20″ when the width W 202 of blade 200 is 0.375″.

A person skilled in the art will note that there is a relationship between the distance D 214 and the width W 202 and the radius R 206 of the dicing and cutting device 100. Certain minimum distances are adhered to prevent the blades 200 from contacting each other.

The inventor has also observed that deviating substantially from the preferred dimensions renders the unit inoperable and/or very difficult to use.

Referring to FIG. 19 with top housing 102 co-operatively engaged with bottom housing 104 in an engaged position 141, the reader will note that the top and bottom blades interpenetrate, such that the opening O 212 defined by the bottom blades 108 receives a top blade 106 there between the space approximately equally distant between the two bottom blades 108.

In this manner the top housing 102 can be rotated relative to the bottom housing 104 by manually spinning and/or turning top housing 102 relative to bottom housing 104 in the engaged position 141. In this manner any food stuff such as garlic 151 as depicted in FIG. 19 will be engaged between the top blades 106 and the bottom blades 108 as the top housing 102 is turned relative to the bottom housing 104, thereby cutting and dicing garlic 151 due to rotationally passing top blades 106 between bottom blades 108.

A person skilled in the art will note that blade 200 is a planar curved section having a thickness T 208 and a radius R 206. The curvature or the radius R 206 of blade 200 is required in order to produce a smooth operation of the dicing and cutting device 100.

It should be apparent to persons skilled in the arts that various modifications and adaptation of this structure described above are possible without departure from the spirit of the invention the scope of which defined in the appended claim.

I claim:

1) A dicing and cutting device comprising:
(a) a top housing slideably and co-operatively engaging with a bottom housing such that the top and bottom housings rotate relative to each other in an engaged position,
(b) wherein the top housing including downwardly projecting blades and the bottom housing including upwardly projecting blades interpenetrating with the downwardly projecting blades, wherein in an engaged position the housing defines a cavity such that foods tuffs located within the cavity are cut and diced upon rotation of the top housing relative the bottom housing.

2) The dicing and cutting device claimed in claim 1 wherein the blades being planar curved sections with a pre-selected radius.

3) The dicing and cutting device claimed in claim 2 wherein each blade having at least one cutting edge extending vertically along the height H of the blade.

4) The dicing and cutting device claimed in claim 4 wherein each blade having a chamfered portion terminating at the cutting edge, the chamfered portion extending vertically parallel to the cutting edge.

5) The dicing and cutting device claimed in claim 2 wherein the angle A of the chamfer being between 21 degrees and 55 degrees.

6) The dicing and cutting device claimed in claim 5 wherein the angle A of the chamfer being 31 degrees.

7) The dicing and cutting device claimed in claim 1 wherein the blades preferably having a planar thickness T being between 0.010 inches and 0.060 inches.

8) The dicing and cutting device claimed in claim 7 wherein the blades preferably having a planar thickness T being 0.035 inches.

9) The dicing and cutting device claimed in claim 2, wherein the blade radius R preferably being one half the diameter of an inner diameter ID.

10) The dicing and cutting device claimed in claim 2, wherein the blade radius R preferably being one half the diameter of an inner diameter ID plus or minus one half inch.

11) The dicing and cutting device claimed in claim 2, wherein the blade radius R preferably being one half the diameter of an inner diameter ID.

12) The dicing and cutting device claimed in claim 1, wherein the top housing and the bottom housing including a co-operatively engaging means for pivoting the top housing relative to the bottom housing.

13) The dicing and cutting device claimed in claim 1, wherein the pivot means including a centrally located pivot axis about which the top housing and the bottom housing rotate.

14) The dicing and cutting device claimed in claim 13, wherein the pivot means including a locating tube and a cooperatively engaging pin such that the pin is slideably and rotatably received within the tube such that in the engaged position the top housing rotates relative the bottom housing about the pin.

15) The dicing and cutting device claimed in claim 14, wherein the top housing including a top locating tube and the bottom housing including a bottom pin such that the pin is slideably and rotatably received within the tube such that in the engaged position the top housing rotates relative the bottom housing about the pin.
